(19) United States
(12) Patent Application Publication
(10) Pub. No.: US 2014/0023761 A1
(43) Pub. Date: Jan. 23, 2014

(54) Coated Popcorn

(71) Applicants: Robert B. Wieland, Cincinnati, OH (US); Theodore T. Pearl, Harrison, OH (US); James R. Works, JR., Alexandria, KY (US)

(72) Inventors: Robert B. Wieland, Cincinnati, OH (US); Theodore T. Pearl, Harrison, OH (US); James R. Works, JR., Alexandria, KY (US)

(73) Assignee: GIVAUDAN S.A., Vernier (CH)

(21) Appl. No.: 13/885,318

(22) PCT Filed: Nov. 18, 2011
(86) PCT No.: PCT/EP2011/070425

§ 371 Date: Sep. 18, 2013

Related U.S. Application Data
(60) Provisional application No. 61/415,037, filed on Nov. 18, 2010.

(51) Int. Cl. A23L 1/00

(52) U.S. Cl. CPC A23L 1/0052
USPC 426/309

(57) ABSTRACT

A process of providing flavoured popcorn kernels, comprising the spraying of popcorn kernels with an aqueous composition, which comprises a slurry in water of a powdered blend of spray-dry flavor and film-forming polymer, the film-forming polymer being adhesive to the kernels at application temperature and sufficient blend being applied to provide an essentially complete coating on the kernels. The process is simple and inexpensive to perform, and allows the ready manufacture of low-fat popcorn.

This disclosure relates to flavored popcorn.

Popcorn is available in two forms, pre-popped and unpopped, the latter being in the form of kernels that may be popped by any convenient means, such as heating in an oven of by microwaving. Traditionally, popcorn kernels have been popped in a bag that also contains a desired flavor and fat, which causes the flavor to adhere to the heated popped popcorn. An increasing interest in fat-reduced products has led to a desire to pre-coat popcorn kernels with flavor, thus substantially avoiding fat. Thus, for example, in U.S. Pat. No. 5,585,127, popcorn kernels are first sprayed with an aqueous adhesive composition, this being followed by a finely-powdered dry flavor composition. This has the disadvantage of involving two processes, the adhesive coating, followed by the flavor coating, which increases the time and energy required, and therefore the cost.

It has now been found that it is possible to provide popcorn kernels with flavor in a simple, efficient and economic process. There is therefore provided a process of providing flavoured popcorn kernels, comprising the spraying of popcorn kernels with an aqueous composition, which comprises a slurry in water of a powdered blend of spray-dry flavor and film-forming polymer, the film-forming polymer being adhesive to the kernels at application temperature and sufficient blend being applied to provide an essentially complete coating on the kernels.

The flavor may be any desired flavor. The most popular flavors are salt and butter flavors, but any other desirable flavor may be used. Examples of such flavors include apple, caramel, sweet brown, pepper and jalapeno.

The film-forming polymer is an edible polymer that is adhesive to the kernels at the application temperature and that is capable of forming an essentially continuous coating on the kernels. This means that the film-forming polymer must be capable of coalescence, that is, that the polymer particles at least partially merge with each other, in the manner of the polymer particles in an emulsion paint. To do this, they must be non-crystalline and sufficiently flexible.

A test for sufficient flexibility comprises casting a film of the polymer from water and then bending it through an angle of about 10°. This film should have the thickness of the theoretical thickness of the coating on the kernel, typically about 20 um. If it bends without snapping, it is suitable; if it snaps, it is not suitable.

The skilled person can readily select a suitable edible polymer from the range available, using only simple, non-inventive experimentation. Typical particular examples of suitable materials include alginate, pectin, cellulose-based materials, complex carbohydrates, gums and dextrins. The polymer may be a blend of such materials. Particular blends include microwave-stable starch and methyl cellulose and/or starch sodium octenylsuccinate. (Starch sodium octenylsuccinate E1450 is a particular type of modified starch used in the food industry). A typical commercially-available microwave-stable starch is National™ 46, ex National Starch Co. The microwave-stable starch may comprise from 1-80% by weight of the mixture, the methyl cellulose from 1-80% and the starch sodium octenylsuccinate from 2-50%. More particularly, all three of microwave-stable starch, methyl cellulose and starch sodium octenylsuccinate are present, in weight proportions of from 60-80%, 10-20% and 5-20% respectively, provided the total percentage is 100.

The spray-dry flavor may be any such flavor known to the art. The blend of polymer and flavor is prepared by conventional blending, using standard equipment and techniques, and the result is a powder of typical maximum size of 50 um.

Other ingredients known to be useful or desirable in popcorn may be added during the blending stage. Non-limiting examples include salt, sweeteners, acids, bitter blockers, mouthfeel enhancers and the like. Particular embodiments that address potential health concerns include sweetness- and salt-enhancers, so that less sugar or salt may be used in achieving the desired flavor level. The quantities used are those known to the art, but typical exemplary concentrations are from about 0.0001%-50% particularly from about 0.0001%-20%, more particularly from about 0.1%-5.0%

The powder is then slurried in water at a weight concentration of from 4-60%, more particularly from 15-30%, and the slurry sprayed on the kernels, such that essentially complete coverage of the kernels is achieved. The spraying may be performed by any convenient means, a particularly advantageous means being the spraying of kernels suspended in a fluidised bed.

In a further embodiment, the powder slurry hereinabove described is sprayed on to the kernels suspended in a fluidised bed, and they are then dried in the fluidised bed. This has the advantage of being a “one-pot” process, which does not require the moving of material from one vessel to another, and thus is a simpler, cheaper process.

In the case of the fluidised bed, the temperatures are not critical and can typically be varied between 50-80° C. and 40-70° C., respectively. Some types of equipment may permit values outside these ranges, but the selection of a suitable temperature is merely an exercise of the ordinary skill of the art.

When popped in, for example, a microwave oven, the popcorn has a full flavor, but a considerably lower fat content than is usually the case.

The development is further described with reference to the following non-limiting examples, which describe particular embodiments.

### EXAMPLE 1

### Sweet Brown Flavour

27 g of sweet brown spray dry flavour (Givaudan No. 97587294), 7.0 g of methyl cellulose and 2 g of starch sodium octenylsuccinate were blended together using a standard ribbon blender to give a powder. (The methyl cellulose/sodium octenylsuccinate blend had previously been cast as a 20 um film and was found to be flexible when bent, with no snapping). This powder was then added to 690 g of water and sprayed on to 4540.0 grams of popcorn kernels being mixed in a Hobart mixer, spraying being continued for 7 minutes. The mixture was then dried for 20-30 min in a fluid bed dryer (a Vector Freund model VFC-5), using an inlet temperature of 60° C. and a bed temperature of 50° C. The final product was a popcorn kernel coated with flavor. The flavoured kernels were storage-stable and the film was robust, allowing for superior handling and storage.

### EXAMPLE 2

### Sweet Brown Flavor; “One-Pot” Process

The materials and quantities of Example 1 were used, except that the popcorn kernels were suspended in a fluidised bed (a Vector Freund model VFC-5) and the powder slurry was sprayed on to the kernels.

The flavoured kernels thus obtained were indistinguishable from those made in Example 1.

### EXAMPLE 3

### Butter Flavour

27 g of butter spray dry flavour, 7.0 g of methyl cellulose and 2 g of starch sodium octenylsuccinate were blended together using a standard ribbon blender. The powder was then added to 690 g of water and coated onto 4540.0 grams of popcorn kernels by spraying and drying as described in Example 1. The final product was a popcorn kernel coated with flavour.

### EXAMPLE 4

### Sweet Brown Flavour Plus Sweetener and Salt

27 g of sweet brown spray dry flavour, 7.0 g of methyl cellulose. 1 g of starch sodium octenylsuccinate, 1 g sucralose and 18 g salt were blended together using a standard ribbon blender. The powder was then added to 690 g of water and coated onto 4540.0 grams of popcorn kernels and dried, as described in Example 1. The final product was a popcorn kernel coated with flavour, sweetener and salt.

### EXAMPLE 5

### Butter Flavor; “One-Pot” Process

27.2 g butter flavor was mixed with 7.3 g methyl cellulose and 1.8 g of starch sodium octenylsuccinate to provide a powder blend. This powder blend (36.3 g) was mixed with 690 g of water to produce a slurry. The slurry (726 g) was sprayed on to popcorn kernels (4540 g) suspended in a fluidized bed apparatus. As the slurry was sprayed on to the kernels in the fluid bed the water was evaporated, to give dry butter flavor-coated popcorn kernels.

### EXAMPLE 6

### Comparison with Existing Products

The product of Example 1 was popped in a microwave. At the same time, a sample of commercially-available sweet brown popcorn kernels was popped under the same conditions. The compositions were as follows:

### Commercially-Available Popcorn

Popcorn kernels 65 g
Flavour 0.3 g
Fat 20.0 g
Salt 2.0 g
Sweetener 0.01 grams

### Coated Popcorn Prepared as in Example 1

Popcorn kernels+flavour coating 75 g
Fat 3.0 g
Salt 2.0 g
Sweetener 0.01 g

A taste panel found the flavors of the two popped corns to be very similar, although the Example 1 product had a fat content considerably less than that of the commercial corn.

Although the embodiments have been described in detail through the above description and the preceding examples, these examples are for the purpose of illustration only and it is understood that variations and modifications can be made by one skilled in the art without departing from the spirit and the scope of the disclosure. It should be understood that the embodiments described above are not only in the alternative, but can be combined.

1. A process of providing flavoured popcorn kernels, comprising the spraying of popcorn kernels with an aqueous composition, which comprises a slurry in water of a powdered blend of spray-dry flavor and film-forming coating polymer, the film-forming coating polymer being adhesive to the kernels at application temperature and sufficient blend being applied to provide an essentially complete coating on the kernels.

2. A process according to claim 1, in which the coating polymer is such that a 20 um film thereof will bend through about 10° without snapping.

3. A process according to claim 1, in which the coating polymer comprises at least one of alginate, pectin, cellulose-based materials, complex carbohydrates, gums or dextrins.

4. A process according to claim 3, in which the coating polymer is a blend of microwave-stable starch and at least one of methyl cellulose or starch sodium octenylsuccinate.

5. A process according to claim 4, in which all three of microwave-stable starch, methyl cellulose and starch sodium octenylsuccinate are present in the respective weight proportions of from 1-80%, from 1-80% and from 2-50%.

6. A process according to claim 1, in which the kernels are suspended in a fluidised bed, sprayed and then dried in the fluidised bed.
